(19) United States
(12) Patent Application Publication
(10) Pub. No.: US 2022/0274138 A1
(43) Pub. Date: Sep. 1, 2022

(54) APPARATUS FOR SEPARATION AND CONVEYING OF CLUMPED PARTICLES, SUCH AS CARBON FIBERS

(71) Applicant: Drexel University, Philadelphia, PA (US)

(72) Inventors: Maria Mercedes DIAZ ACEVEDO, Philadelphia, PA (US); Simge UZUN, Philadelphia, PA (US); Nicolas Javier ALVAREZ, Drexel Hill, PA (US); Giuseppe Rafaello PALMESE, Hainesport, NJ (US)

(73) Assignee: Drexel University, Philadelphia, PA (US)

(21) Appl. No.: 17/631,556

(22) PCT Filed: Jul. 31, 2020
(86) PCT No.: PCT/US2020/044525

§ 371 Date: Jan. 31, 2022

Related U.S. Application Data
(60) Provisional application No. 62/881,580, filed on Aug. 1, 2019.

(51) Int. Cl. B07B 9/02; D01G 5/00; B07B 7/06; B07B 7/01

(52) U.S. Cl. CPC B07B 9/02; D01G 5/00; B07B 7/06; B07B 7/01

(57) ABSTRACT

The present invention is an apparatus and method of using the apparatus for separating individual particles from a collection of clumps (or bundles or aggregates) of particles. The apparatus has n number of separation columns, wherein each separation column is connected at an upper portion thereof to at least one fluid connection, and a particle collector. A pressurized fluid flows through the apparatus and 1) suspends a portion of the clumps within the separation column and/or the at least one fluid connection thereby separating at least some clumps into smaller clumps and/or individual particles; and 2) conveys a portion of the clumps and/or individual particles to the next separation column in the series of separation columns, or, in the case of the nth separation column conveys individual particles to the particle collector.

### CROSS REFERENCE TO RELATED APPLICATIONS

This application claims the benefit of U.S. Provisional Application No. 62/881,580, filed on Aug. 1, 2019, the entire disclosure of which is hereby incorporated by reference as if set forth fully herein.

### STATEMENT OF GOVERNMENT INTEREST

This invention was made with government support under Contract No. HR0011-16-2-0014 awarded by the Department of Defense, Defense Advanced Research Projects Agency. The government has certain rights in the invention.

### TECHNOLOGY

The present invention relates to methods of separating individual particles from a collection of clumps (or bundles or aggregates) of particles and individual particles by providing pressurized fluid into a series of separation columns wherein the pressurized fluid has sufficient velocity so as to suspend a portion of the clumps thereby separating at least some clumps into smaller clumps and/or individual particles. The particles can be collected with minimal or no clumping. Also disclosed is an apparatus for performing the method.

### BACKGROUND ART

Carbon fibers are widely used in composite applications to improve properties of bulk composite products. They are used in polymer, metal, and ceramic composites to enhance many properties such as bulk tensile strength, stiffness, toughness, bulk weight, coefficient of thermal expansion (CTE), temperature stability of the composite product, and conductivity. The uniformity of short carbon fiber's dispersion affects the performance of carbon fiber reinforced composites. However, one of the challenges of their processing is the difficulty to first obtain dispersed short carbon fibers with minimal clumping which can be uniformly dispersed into the matrix.

U.S. Pat. No. 2,931,076 discloses an apparatus and method for separating fibrous structures. Bundles of fibers are fed into a tube with a feeder. The tube has an air flow in a downward direction. The fiber clumps are transported to a dispersing chamber containing a series of blades and a porous collecting wall. The action of the blades, the air flow and the holes in the collecting wall provide a disintegrating action for separating fiber bundles into the individual components. The action of the blades would damage the fibers.

U.S. Pat. No. 3,521,998 discloses a method and apparatus for treating fibrous materials providing an upright treating chamber filled with fibrous material. Additional fibrous material is continuously added at one end of the treating chamber, and a corresponding quantity of fibrous material is continuously withdrawn at the other end of the treating chamber so that new fibrous material added advances through the treating chamber from one to the other end thereof. An aerosol is introduced into the treating chamber for passage through the fibrous material therewithin either in concurrent flow with the fibrous material, or in counterflow thereto. At the respectively opposite end of the treating chamber the aerosol is withdrawn. The intended purpose of the method of U.S. Pat. No. 3,521,998 is to temporarily separate fibers in a column and provide a uniform surface treatment of the fibers with the aerosol as the fibers fall down the column, but U.S. Pat. No. 3,521,998 does not intend to maintain the separation after the surface treatment, since the rollers near the bottom would tend to combine the separated fibers.

The fiber cartridge aerators of U.S. Pat. Nos. 2,931,076; 3,521,998 are not able to separate and collect individual particles from clumps without substantially damaging the individual particles in the process.

### SUMMARY OF THE INVENTION

The present invention solves the problems of the prior art fiber cartridge aerators by having the ability to collect individual particles from clumps without substantially damaging the individual particles in the process.

In a first aspect, disclosed is an apparatus for separating individual particles from a collection of clumps (or bundles or aggregates) of particles, comprising n number of separation columns, wherein each separation column is connected at an upper portion thereof to at least one fluid connection, wherein one of the separation columns connected to at least one fluid connection is defined as a particle separating zone thereby forming n particle separating zones,

each separation column including a porous or nonporous structure located at a lower end of said separation column;

a particle collector;

a particle feeder fluidly connected to a first of said separation columns, said particle feeder being configured to feed both particles and clumps of particles to the first of said separation columns;

the nth fluid connection is connected at a downstream point to the particle collector;

one or more fluid sources which are fluidly connected with each of the separation columns for supplying pressurized fluid to the particle separating zone, wherein each of the one or more fluid sources supplies pressurized fluid: i) through the porous or nonporous structure located at the lower end of the separating column; ii) through an opening in the separation column; iii) through an opening in the fluid connection; or iv) through an opening in the particle feeder,

wherein said fluid sources are configured such that said pressurized fluid:
a) suspends a portion of the clumps above the porous or nonporous structure and within the particle separating zone thereby separating at least some clumps into smaller clumps and/or individual particles; and
b) conveys a portion of the clumps and/or individual particles to the next separation column in the series of separation columns, or, in the case of the nth separation column conveys individual particles to the particle collector.

In the foregoing embodiment, there may be 1 to 8, or 1 to 5, or 1 to 3, or 1 fluid connection(s) attached to a separation column.

In each of the foregoing embodiments, there may be 1 fluid connection attached to each separation column in the apparatus.

In each of the foregoing embodiments, the length of the fluid connection may be determined by the average mass, average size and average shape of the particles and/or clumps of particles.

In each of the foregoing embodiments, said fluid sources may be configured such that said pressurized fluid b) conveys a portion of the clumps and/or individual particles below a predetermined size to the next separation column in the series of separation columns.

In each of the foregoing embodiments, each separation column may be in a vertical alignment parallel to the direction of gravity, or the tube of the separation column may be at an off angle, such as 45° or less from vertical.

In each of the foregoing embodiments, the length of the first separation column may be 0.5 m to 30 m, or 0.8 m to 15 m or 1 m to 3 m, and the diameter of the at least one separation column may be 2 cm to 200 cm or 5 cm to 100 cm or 10 cm to 30 cm.

In each of the foregoing embodiments, the average length of all separation columns in the apparatus may be 0.5 m to 30 m, or 0.8 m to 15 m, or 1 m to 3 m, and the average diameter of all the separation columns in the apparatus may be 2 cm to 200 cm, or 5 cm to 100 cm, or 10 cm to 30 cm.

In each of the foregoing embodiments, the length of the at least one fluid connection may be 5 cm to 3 m, or 10 cm to 1.5 m or 20 cm to 1 m, and the diameter of the at least one fluid connection may be 2 cm to 200 cm or 5 cm to 100 cm or 10 cm to 30 cm.

In each of the foregoing embodiments, the average length of all fluid connections in the apparatus may be separately measured as 5 cm to 3 m, or 10 cm to 1.5 m or 20 cm to 1 m, and the average diameter of all the fluid connections in the apparatus may be 2 cm to 200 cm or 5 cm to 100 cm or 10 cm to 30 cm.

In each of the foregoing embodiments, the length of at least one particle separating zone may be 0.55 m to 33 m, or 0.81 m to 16.5 m, or 1.2 m to 4 m, and the diameter of the at least one particle separating zone may be 2 cm to 200 cm or 5 cm to 100 cm or 10 cm to 30 cm.

In each of the foregoing embodiments, the average length of all particle separating zones in the apparatus may be 0.55 m to 33 m, or 0.81 m to 16.5 m, or 1.2 m to 4 m, and the average diameter of all the particle separating zone in the apparatus may be 2 cm to 200 cm or 5 cm to 100 cm or 10 cm to 30 cm.

In each of the foregoing embodiments, the apparatus may be configured so that less than 10% of the individual particles collected in the particle collector are broken into significantly smaller particles during operation of the apparatus.

In each of the foregoing embodiments, the porous structure at the lower end of the separation column may be configured to collect the clumps that are too heavy to be suspended by the pressurized fluid.

In each of the foregoing embodiments, said particle feeder may include:
a) a hopper configured to hold a collection of clumps of particles and individual particles to be separated,
b) a barrel,
c) a valve located between said hopper and said barrel, said valve being configured to regulate flow of the clumps of particles and individual particles from the hopper into the barrel, and
d) a source of pressurized fluid fluidly connected to said barrel and configured for conveying the clumps of particle and the individual particles from said hopper to the first of said particle separating zones.

In each of the foregoing embodiments, the air flow rate within the barrel of the particle feeder and within the separation columns may be 0.1-3000 CFM, or 0.1-1000 CFM, or 0.1-300 CFM, or 3-300 CFM.

In each of the foregoing embodiments, the diameter of the barrel may be 2 to 30 cm, and the length of the barrel from the point where the particles enter the barrel until the barrel connects to the first separation column may be 15 cm to 1 m.

In each of the foregoing embodiments, the value of n may be 1 to 20; or 1 to 15; or 2 to 10; or 2 to 5.

In each of the foregoing embodiments, said particle collector may further comprise a spraying unit for spraying polymer resin on the individual particles fed to the particle collector.

In each of the foregoing embodiments, the openings in said porous structure in the separation columns may be sized to collect clumps and allow fluid to enter the particle separating zone.

In each of the foregoing embodiments, the pressurized fluid may be supplied to the first particle separating zone such that the velocity is specified to drag all particles above a given lengthscale into the second separation column.

In each of the foregoing embodiments, the pressurized fluid may be supplied to a second of the n particle separating zones such that the velocity is specified to drag a smaller subset of particles into the third separation column.

In each of the foregoing embodiments, the pressurized fluid may be supplied to the nth particle separating zone such that the velocity is specified to drag a single particle into the final collection column.

In each of the foregoing embodiments, the apparatus may further comprise a porous structure located inside of and proximate a lower end of the particle collector to allow passage of fluid out of the particle collector while preventing passage of individual particles.

In each of the foregoing embodiments, the velocity of the fluid may be controlled by at least one selected from the group consisting of: a) a valve; b) diameter of separation column; c) diameter of fluid connection; d) separation column is shaped to have a tapering; e) fluid connection is shaped to have a tapering; and f) one or more porous structures in a wall of the separation column or fluid connection.

In each of the foregoing embodiments, the velocity of the fluid in the fluid connection connecting the separation columns may be controlled by at least one selected from the group consisting of: a) a valve; b) diameter of pipe; c) diameter of fluid connection; d) pipe shaped to have a tapering; and e) fluid connection is shaped to have a tapering; and f) one or more porous structures in a wall of the connecting pipe or fluid connection.

In each of the foregoing embodiments, at least one separation column may have a porous structure at a lower end thereof.

In each of the foregoing embodiments, at least one separation column may have a nonporous structure at a lower end thereof.

In each of the foregoing embodiments, at least one separation column may have a porous structure at a lower end thereof and at least one separation column may have a nonporous structure at a lower end thereof.

In a second aspect, is a method of separating individual particles from a collection of clumps (or bundles or aggregates) of particles and individual particles with an apparatus comprising a series of n number of separation columns, wherein each separation column is connected at an upper portion thereof to at least one fluid connection, wherein one of the separation columns connected to at least one fluid connection is defined as a particle separating zone thereby forming n particle separating zones, and each separation column has a porous or nonporous structure at a lower end of the separation column, said method comprising steps of:

(A) providing the clumps of particles and individual particles to the first particle separating zones,

(B) providing pressurized fluid into each said particle separating zone with sufficient velocity so as to:
(i) suspend a portion of the clumps above the porous or nonporous structure and within the particle separating zone thereby separating at least some clumps into smaller clumps and/or individual particles; and
(ii) convey through a fluid connection having a predetermined length a portion of the clumps and/or individual particles to the next separation column in the series of separation columns, or, in the case of the nth separation column convey individual particles to a particle collector; and

(C) collecting individual particles in the particle collector,

wherein the pressurized fluid is supplied by one or more fluid sources: i) through the porous or nonporous structure located at the lower end of the separation column; ii) through an opening in the separation column; iii) through an opening in the fluid connection; or iv) through an opening in a particle feeder configured to provide the clumps of particles and individual particles to the first particle separating zone.

In the foregoing embodiment, there may be 1 to 8, or 1 to 5, or 1 to 3, or 1 fluid connection(s) attached to a separation column.

In each of the foregoing embodiments, there may be 1 fluid connection attached to each separation column in the apparatus.

In each of the foregoing embodiments, less than 10% of the individual particles collected in the particle collector may be broken into significantly smaller particles.

In each of the foregoing embodiments, the method may be carried out as a continuous process or a batch process.

In each of the foregoing embodiments, said method may further comprise supplying pressurized fluid vertically through the porous structure at the lower end of each said separation column, and wherein said pressurized fluid moves further within the fluid connection in a direction that is not vertical.

In each of the foregoing embodiments, the length of the fluid connection may be determined by the average mass, average size and average shape of the particles and/or clumps of particles.

In each of the foregoing embodiments, said pressurized fluid may move within the fluid connection in a horizontal direction.

In each of the foregoing embodiments, the fluid moving through the fluid connection may not have sufficient velocity to move all clumps and individual particles entering the fluid connection completely through the fluid connection.

In each of the foregoing embodiments, the clumps and/or individual particles that enter the fluid connection but do not move completely through the fluid connection, may be returned to the previous separation column.

In each of the foregoing embodiments, the clumps and/or individual particles that do not move completely through the fluid connection, may be returned to the previous separation column with the aid of vibration of the walls of the fluid connection and/or gravity.

In each of the foregoing embodiments, the cohesiveness of the clumps may be overcome with air flow, collisions between individual clumps and collisions between clumps and inner walls of the apparatus in a flow path of the clumps and individual fibers.

In each of the foregoing embodiments, cohesiveness of the clumps may be overcome mainly by laminar air flow over the flow path of the clumps and individual fibers.

In each of the foregoing embodiments, the velocity of fluid in the apparatus may be increased if the yield of individual particles in the particle collector is less than 10%, or less than 5%, or less than 1% of starting material exiting the particle feeder.

In each of the foregoing embodiments, the fluid flow may be laminar and have a Reynolds Number of <3,000 with respect to the separation column and fluid connections, or wherein the fluid flow may be laminar and have a Reynolds Number between 100-2100 with respect to the separation column and fluid connections, or wherein the fluid flow may be laminar and have a Reynolds Number between 200-400 with respect to the separation column and fluid connections.

In each of the foregoing embodiments, at least 1 wt. %, or 1 to 10 wt. %, or at least 25 wt. %, or at least 30 wt. % or at least 50 wt. % of the clumps of particles and the individual particles used as starting material may be collected as individual particles in the particle collector.

In each of the foregoing embodiments, the individual particles may have an aspect ratio of 1 to 30,000; or 50 to 30,000; or 1 to 1000; or 50 to 1000; or 100 to 1000; or greater than 300 to 1000.

In each of the foregoing embodiments, there may further comprise a preprocessing step of breaking apart clumps of particles to reduce size of the clumps before being placed in the apparatus.

In each of the foregoing embodiments, there may be no preprocessing step of breaking apart clumps of particles to reduce size of the clumps before being placed in the apparatus.

In each of the foregoing embodiments, the particles may not be asbestos.

In each of the foregoing embodiments, the porous structure at the lower end of each said separation column may have sufficient porosity to allow for fluid flow into the lower end of the separation column while preventing passage of the clumps of particles and the individual particles; or the porous structure at the lower end of each said separation column may be formed of a PTFE fiberglass fabric.

In each of the foregoing embodiments, the particle collector may comprise a length of tube (e.g., 10 cm-3 m) in a generally vertical direction connected at a top thereof to a fluid connection and a collection zone comprising a porous structure at the lower end of the particle collector having sufficient porosity to allow for air flow out of the lower end of the particle collector while preventing passage of individual particles; or wherein the porous structure at the lower end of the collection zone may be formed of a PTFE fiberglass fabric.

In each of the foregoing embodiments, the particles may be at least one selected from the group consisting of fiber particles, polymeric particles, protein particles, and cellulose particles; or wherein the particles may be natural fiber particles, or wherein the particles may be carbon fiber particles, metal fiber particles, polyamide particles, or peptide particles, or wherein the particles may be carbon fiber particles.

In each of the foregoing embodiments, the particle collector may have either a porous structure at the lower end or may be positioned near a liquid bath or a moving conveyor belt for collection of the individual particles.

In each of the foregoing embodiments, the particle collector may be at least two metal plates on opposite walls and which are sufficiently charged to electrostatically align the particles in the same direction.

In each of the foregoing embodiments, particle collector(s) may be placed at the lower end of one or more separation columns.

In each of the foregoing embodiments, the method further comprising collecting particles that have passed through at least one particle separating zone in a resin bath to form a mixture of resin and particles, and curing the resin.

In each of the foregoing embodiments, the resin is a thermoset resin or a thermoplastic resin or an epoxy resin.

An advantage of the invention is that there is no solvent required to keep the fibers dispersed. It is an environmentally friendly and a clean process, i.e., clumped fibers may be returned to a fiber feeding apparatus for recirculation through the system, with negligible waste. The fibers disperse from clumps (tows, bundles, or aggregates) to single fibers at the end of the process. Advantages over liquid dispersion include no clumping, homogeneous deposition, and high volume fraction.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. it is to be understood that both the foregoing general description and the following detailed description are exemplary and explanatory only and are not restrictive of the disclosure, as claimed.

### BRIEF DESCRIPTION OF THE DRAWINGS

Each figure discusses or shows a particular embodiment of the invention.

FIG. 1 is a photograph of an embodiment of the invention with arrows showing the direction of flow of the fluid and particles within the apparatus.

FIG. 2 is an embodiment wherein the air flow is maintained at a maximum air flow rate of 0.5 m/s and is homogeneous.

FIG. 3 is a photograph of a flow meter having 2 slits for checking the homogeneity of the air flow.

FIG. 4 is a first photograph showing a separation column having a nonporous structure located at the lower end of the separation column and a second photograph showing a separation column having a porous structure located at the lower end of the separation column.

FIG. 5 is a graph of the values of the average velocity in feet/minute for a fully closed setup (separation column having a nonporous structure located at the lower end) and a mesh setup (separation column having a porous structure located at the lower end).

FIG. 6 is a photograph showing the size and geometry of bundles of particles prior to separation.

FIG. 7 is a photograph showing different geometries of the fluid connection between the separation columns and points of possible accumulation of fibers.

FIG. 8 is a representation of an embodiment of the inventive apparatus.

FIG. 9 is a mathematical expression of the particle dynamics.

FIG. 10 describes factors in determining the drag coefficient C_{d} on the fiber or bundle.

FIG. 11 describes other variables relevant to the invention.

FIG. 12 is a graph of the particle trajectory.

FIG. 13 is a graph of time and distance to fall with increased number of fibers in the bundle (or clump).

FIG. 14 is a table of data for an embodiment of the invention.

FIG. 15 is a setup for fibers to fall in a resin.

FIG. 16 are photographs of the material after curing the resin.

FIG. 17 shows a distribution of the number of fibers in each alignment within a composite.

FIG. 18 are photographs of the vat wherein fibers are collected.

FIG. 19 are photographs of the material after curing of the resin.

FIG. 20 shows a distribution of the number of fibers in each alignment within a composite.

FIG. 21 is a photograph of an apparatus which is an embodiment of the invention.

FIG. 22 shows the parameters of the Reynolds Number with respect to a tube.

### DETAILED DESCRIPTION OF THE INVENTION

### Definitions

“Down” is the direction of the force of gravity.

“Up” is the opposite direction to down.

“Vertical” is parallel to the direction of the force of gravity.

“Horizontal” is a plane at a 90° angle to vertical.

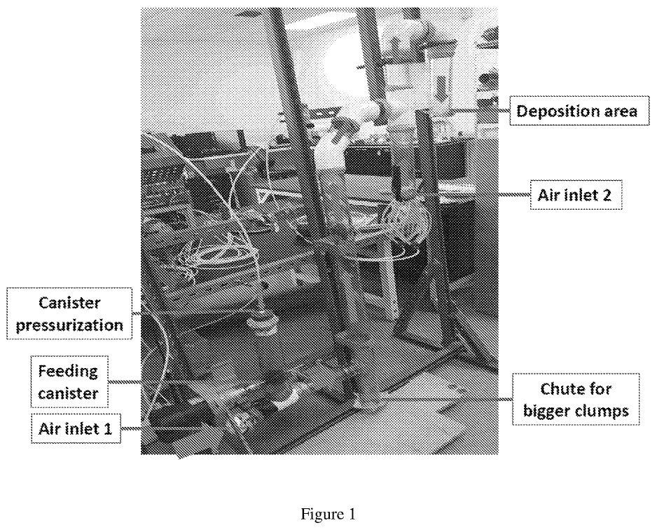

“Length” is the measurement or extent of something from end to end. Herein, the length of a piece of the apparatus is measured parallel to the flow of the fluid within. For instance, in FIG. 1, the length of the first separation column would be a measurement of the distance from the bottom of the separation column to the point at which the fluid changes its angle as it enters the next section, i.e., the first fluid connection.

“Diameter” is measured in a plane at a cross section of the tube perpendicular to the general direction of flow of the fluid therein.

FIG. 1 is a photograph showing an embodiment of the invention that is an apparatus for separating individual particles from a collection of clumps (or bundles or aggregates) of particles. The apparatus includes a particle collector identified as “Deposition area” in FIG. 1 for collecting the individually separated particles. The apparatus of FIG. 1 is on a lab scale. The size of the apparatus can be increased or decreased for increased output or smaller footprint, respectively.

The inventive apparatus includes a particle feeder fluidly connected to a first of a series of separation columns, said particle feeder being configured to feed both particles and clumps of particles to the first of said series of separation columns. Separation of the particles is independent of how the particles or clumps of particles are introduced into the first of said series of separation columns by the particle feeder. The particles can still be separated from the clumps using different methods of introducing the clumps into the first separation column. The barrel and pressurized injector can help to reduce the number of stages. However, the efficiency of separation will depend on the method of introducing the particles or clumps of particles into the first of said series of separation columns.

In FIG. 1, the particle feeder is identified as “Feeding canister” that is pressurized from the top of the canister with the fluid. This particle feeder is fluidly connected to a first of a series of separation columns, and the particle feeder is configured to feed both particles and clumps of particles to the first separation column. The particle feeder includes: a) a hopper configured to hold a collection of clumps of particles and individual particles to be separated, b) a barrel, and c) a valve located between said hopper and said barrel, said valve being configured to regulate flow of the clumps of particles and individual particles from the hopper into the barrel. In FIG. 1, the hopper is in a vertical tube and is connected to the barrel which is a horizontally oriented tube. However, the hopper tube can be at an off angle, such as 45° or less from vertical, and the barrel can be at an off angle, such as 45° or less from horizontal. At the top of the hopper is a plug with a hole acting as a fluid inlet for pressurizing the hopper, so that the hopper acts as a pressurized injector. One type of valve that can be used will open at a threshold fluid pressure thereby allowing clumps of fibers and individual fibers to drop into the barrel. Manual and automatic mechanical and electrical valves can also be used. The barrel is also plugged at one end with a hole acting as a fluid inlet. The diameter of the barrel can be 2 to 30 cm. The length of the barrel from the point where the particles enter the barrel until the barrel connects to the first separation column can be 15 cm to 1 m.

However, it is noted that separation of the particles is independent of how the particles or clumps of particles are introduced into the first of said series of separation columns by the particle feeder. The particles can still be separated from the clumps using different methods of introducing the clumps into the first separation column. The barrel and pressurized injector can help to reduce the number of stages. Nevertheless, the efficiency of separation will depend on the method of introducing the particles or clumps of particles into the first of said series of separation columns.

Also, the mass flow rate of the particles entering the first separation column from the particle feeder is controlled so that the particles do not clog or jam within the first separation column.

In the inventive apparatus, there is one or more fluid sources which are fluidly connected with each of the separation columns for supplying pressurized fluid to the separation column. Each of the one or more fluid sources supplies pressurized fluid: i) through the porous structure or through an opening in the nonporous structure located at the lower end of the separation column; ii) through an opening in the separation column; iii) through an opening in the fluid connection; or iv) through an opening in the particle feeder. In the apparatus of FIG. 1, a fluid source is connected to the particle feeder and is identified as “Air inlet 1”. The direction of flow of the air through the apparatus is shown in FIG. 1 with arrows. The pressurized fluid (air) conveys the clumps of particle and the individual particles from said hopper to the first of said separation columns. Also, in the apparatus of FIG. 1, there is a fluid source at the bottom of the second separation column identified “Air inlet 2”. In an embodiment, the fluid can enter the bottom of the separation column through more than one port. In the apparatus of FIG. 1, the air enters the bottom of the second separation column through 16 separate ports. Having more than one port can improve the homogeneity of the flow of the fluid into the particle separating zone.

The fluid can be any substance which is a gas at the temperature of operation of the apparatus. Preferably, the fluid is air, oxygen, nitrogen, carbon dioxide, hydrogen, or a noble gas such as neon or argon, or combinations thereof.

The velocity of the fluid is controlled by at least one selected from the group consisting of: a) a valve; b) diameter of separation column; c) diameter of fluid connection; d) a tapering shape of the separation column; e) a tapering shape of the fluid connection; and f) one or more porous structures in a wall of the separation column or fluid connection. The air flow rate within the barrel of the particle feeder and within the separation columns can be 0.1-3000 CFM, or 0.1-1000 CFM, or 0.1-300 CFM, or 3-300 CFM. Preferably, the air flow rate within the barrel of the particle feeder is faster than the air flow rate in the first separation column. Also, it is preferred that every separation column has an air inlet at the bottom of each separation column.

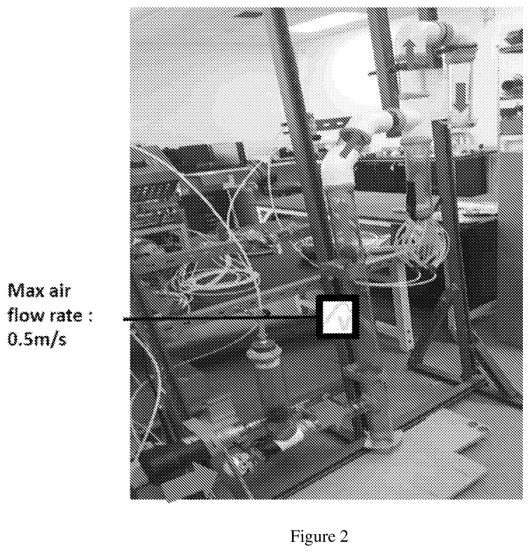

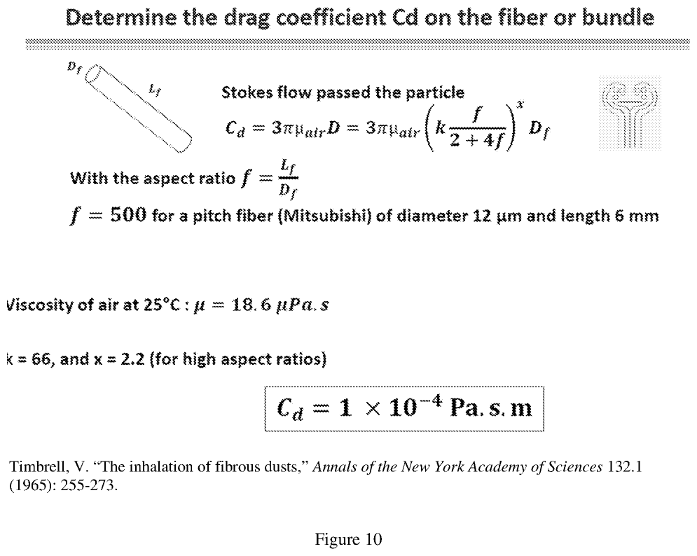

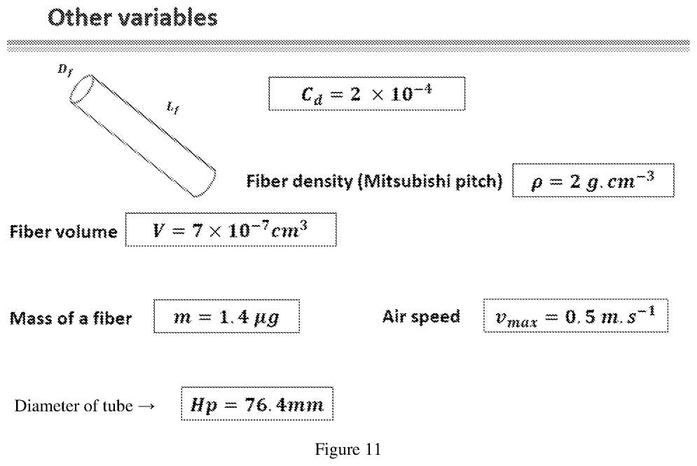

The air flow rate can be modified to accommodate for other factors such as a change in the diameter of the piping. For instance, if the piping of the first separation column is columnar in shape and has an average diameter of 10.16 cm with an air flow rate of 3 CFM, then increasing the diameter of the piping to 61 cm would require an increase in air flow rate to be 108 CFM. Also, an increase in the length of a fluid connection can be accommodated by an increase in the air flow rate within the fluid connection. In the embodiment of the apparatus of FIG. 1, the air flow rate at the Air inlet 1 can be 3-100 CFM, the 1st separation column can have a nonporous structure located at the lower end, and the air flow rate of Air inlet 2 can be 1-1000 CFM. In the embodiment of FIG. 2, the maximum velocity in the first separation column is kept to 0.5 m/s (which is about 340 CFM) when using the Mitsubishi fibers described in FIGS. 10 and 11.

The velocity of fluid in the apparatus can be increased if the yield of individual particles in the particle collector is less than 10 wt. %, or less than 5 wt. %, or less than 1 wt. % of the total weight of the starting material exiting the particle feeder. Preferably, at least 1 wt. %, or 1 to 10 wt. %, or at least 25 wt. %, or at least 30 wt. % or at least 50 wt. % of the clumps of particles and the individual particles used as starting material is collected as individual particles in the particle collector. Generally, higher yields can be obtained with a longer running time of the apparatus.

The apparatus can have a series of n number of separation columns, each separation column includes a porous or nonporous structure located at a lower end of the separation column. The porous structure can have sufficient porosity to allow for fluid to flow into the lower end of the particle separating zone while preventing passage of the clumps of particles and the individual particles; or the porous structure at the lower end of each said separation column is formed of a PTFE fiberglass fabric. Each separation column is generally in a vertical alignment parallel to gravity, but the tube of the separation column can be at an off angle, such as 45° or less from vertical. Also, the value of n can be 1 to 20; or 1 to 15; or 2 to 10; or 2 to 5. In the apparatus of FIG. 1, there are 2 vertically oriented separation columns (i.e., n=2).

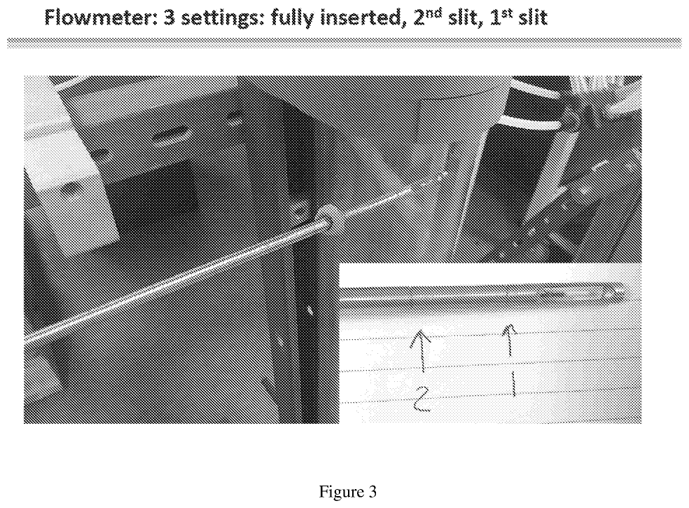

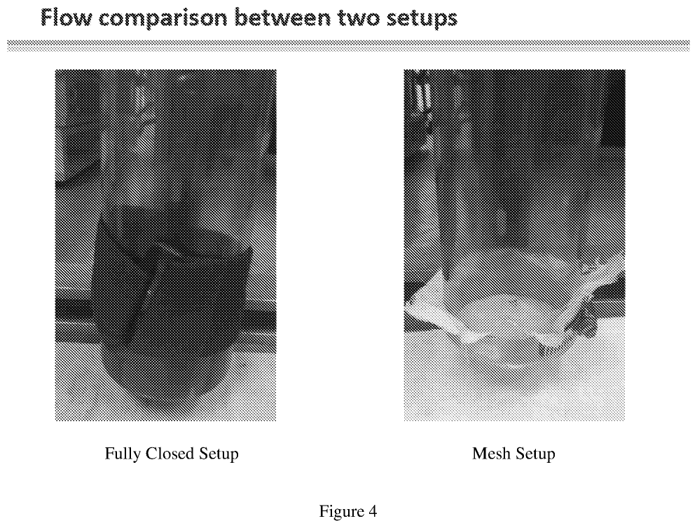

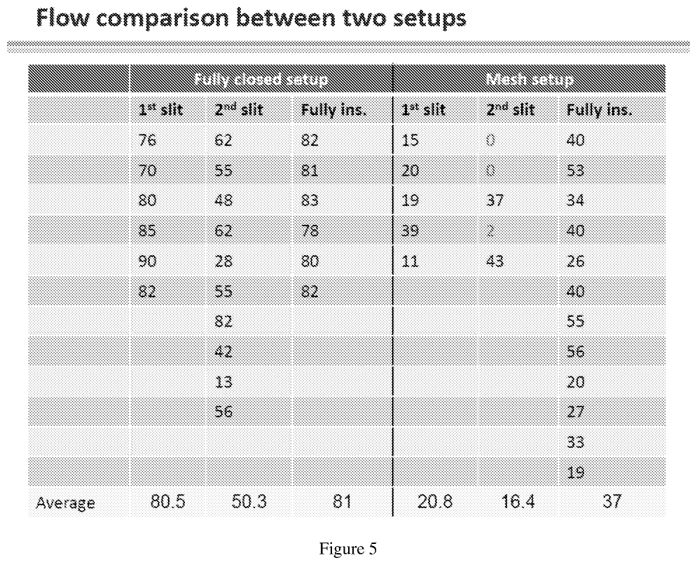

Examples of the porous structure and nonporous structure at the lower end of the separation columns are shown in FIG. 4. FIG. 5 is a graph of the values of the average velocity in feet/minute for a fully closed setup (separation column having a nonporous structure located at the lower end thereof) and a mesh setup (separation column having a porous structure located at the lower end thereof), as measured by the slits in a flow meter (see FIG. 3).

In an embodiment, the length of the first separation column is 0.5 m to 30 m, or 0.8 m to 15 m, or 1 m to 3 m, and the diameter of at least one separation column is 2 cm to 200 cm, or 5 cm to 100 cm, or 10 cm to 30 cm. In an embodiment, the average length of all separation columns in the apparatus is 0.5 m to 30 m, or 0.8 m to 15 m, or 1 m to 3 m, and the average diameter of all the separation columns in the apparatus is 2 cm to 200 cm, or 5 cm to 100 cm, or 10 cm to 30 cm. In an embodiment, the second separation column is shorter in length than the first separation column. In another embodiment, each subsequent separation column is shorter than the separation column immediately preceding it.

In the inventive apparatus, there is a fluid connection having a predetermined length between an upper portion of each said separation column to either a lower portion of the next said separation column or, in the case of the nth separation column to the particle collector. There can be multiple fluid connections for each separation column, such as 1 to 8, or 1 to 5, or 1 to 3 fluid connections attached to a separation column. Preferably, there is 1 fluid connection attached to each separation column in the apparatus. In the apparatus of FIG. 1, there is a fluid connection having a bend in the middle, and the fluid connection is generally in a horizontal orientation, but can be configured at an angle of 45° to 90° from the direction of gravity, and connects an upper portion of the first separation column to the second separation column. In an embodiment, the length of the at least one fluid connection is 5 cm to 3 m, or 10 cm to 1.5 m, or 20 cm to 1 m, and the diameter of the at least one fluid connection is 2 cm to 200 cm, or 5 cm to 100 cm, or 10 cm to 30 cm. In an embodiment, the average length of all fluid connections in the apparatus is separately measured as 5 cm to 3 m, or 10 cm to 1.5 m, or 20 cm to 1 m, and the average diameter of all the fluid connections in the apparatus is 2 cm to 200 cm, or 5 cm to 100 cm, or 10 cm to 30 cm.

Each separation column in the series of n separation columns is connected at an upper portion thereof to at least one fluid connection. A particle separating zone is defined by a portion of the apparatus constituted by one separation column connected to at least one fluid connection. This means that there are n particle separating zones. As noted above, the separation column is a section relatively or exactly parallel to gravity and the fluid connection is a portion relatively or exactly perpendicular to gravity. In the separation column, larger clumps are reduced to smaller clumps via a rotating or vortex like flow field. In the fluid connection, smaller clumps are separated by bigger clumps via a competition of drag and gravity. In the section of the particle separating zone constituting the separation column, there is a velocity component generally in the opposite direction of gravity (i.e. if gravity is pointing down, then there is some component of flow pointing up), and in the second section of the particle separating zone constituting the fluid connection, there is a velocity component generally perpendicular to the force of gravity (i.e. if gravity is pointing down, then there must be some component of flow pointing left or right). In an embodiment, the length of at least one particle separating zone is 0.55 m to 33 m, or 0.81 m to 16.5 m, or 1.2 m to 4 m, and the diameter of the at least one particle separating zone is 2 cm to 200 cm, or 5 cm to 100 cm, or 10 cm to 30 cm. In an embodiment, the average length of all particle separating zones in the apparatus is 0.55 m to 33 m, or 0.81 m to 16.5 m, or 1.2 m to 4 m, and the average diameter of all the particle separating zone in the apparatus is 2 cm to 200 cm, or 5 cm to 100 cm, or 10 cm to 30 cm.

The separation column and/or the fluid connection can also include a valve, which when open, adds fluid flow into the separation column and/or the fluid connection.

The shape of the cross section of the pipes constituting the particle separating zone can be any suitable shape, such as square, rectangle, triangle or circular. Preferably the shape of the cross section is circular. At least one separation column can be tapered having a larger diameter in an upper portion thereof and a smaller diameter in a lower portion thereof. A fluid connection can also be tapered and/or have a bend.

As noted above, the inventive apparatus includes a particle collector, which is downstream of the n separation columns. The nth separation column is connected by a fluid connection to the particle collector. The particle collector comprises a porous structure located inside of and proximate a lower end of the particle collector having sufficient porosity to allow for air flow out of the lower end of the particle collector while preventing passage of individual particles. The particle collector can also comprise a length of tube in a generally vertical direction above the collection zone. In an embodiment, the porous structure at the lower end of the collection zone is formed of a PTFE fiberglass fabric. In an embodiment, the particle collector is positioned near a liquid bath or a moving conveyor belt for collection of the individual particles. In an embodiment, the particle collector has at least two metal plates on opposite walls and which are sufficiently charged to electrostatically align the particles in the same direction. In an embodiment, particle collector(s) can be placed at the lower end of one or more of the separation columns.

Deposition can be controlled by: a) air flow rate at the inlets (m³·s⁻¹) (also referred to as fluid sources); b) flow in the 1^{st} separation column (m³·s⁻¹); and c) the fiber feeding rate (g·min⁻¹). Herein the air inlets are the openings for fluid sources. Fibers are deposited and can be oriented as they land in the final particle collector, and can be oriented in a mat, the distance between fibers can be controlled, and the aspect ratio can remain essentially the same in view of the fact that the particles have little to no breakage.

In the apparatus of FIG. 1, the air from the Air inlet 1 advances the particles and clumps of particles from the particle feeder into the first separation column. The air entering the first separation column advances the particles and clumps of particles in an upward direction within the first separation column. The flow of the air is set at a point which can advance individual particles up to the fluid connection, but large clumps will fall down the chute to a trap at the bottom of the first separation column identified in FIG. 1 as “Chute for bigger clumps”. The midsized clumps are suspended in the separation column usually with a “bouncing” action of moving up and down. The particles can collide with one another, and with the walls of the separation column. The action of the air flow and these collisions gently overcomes the cohesiveness of these midsized particles and breaks them apart into smaller clumps and individual particles. Preferably, less than 10%, or less than 5% of the total number of individual particles collected in the particle collector are broken into significantly smaller particles.

The cohesiveness of the clumps can be overcome mainly by laminar air flow over the flow path of the clumps and individual particles. The laminar air flow can have a Reynolds Number of <3,000 for the particles, or wherein the air flow is laminar and has a Reynolds Number between 100-2100 for the particles, or wherein the air flow is laminar and has a Reynolds Number between 200-400 for the particles. Once the clumps decrease to a threshold predetermined size, these smaller clumps and individual particles will advance by the flow of air into the fluid connection. FIG. 2 is an embodiment wherein the air flow is maintained at a maximum velocity of air is 0.5 m/s and is homogeneous. The homogeneity of the air flow can be measured with a flow meter having more than one slit as shown in FIG. 3.

The size, shape and fluid flow rate of each particle separating zone can be designed separately to control the size of the clumps which are allowed to pass through to the next particle separating zone.

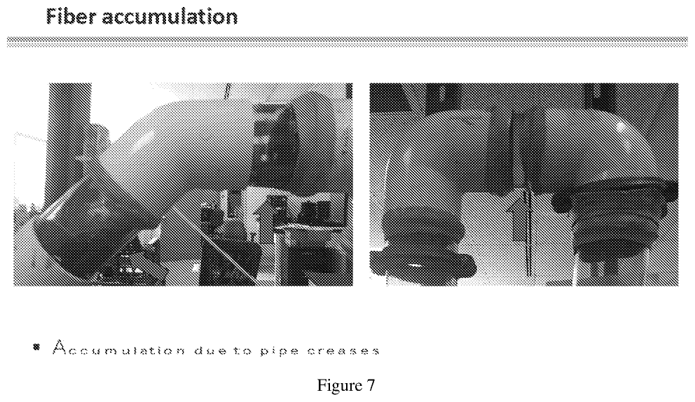

The fluid connection is an important part of the inventive apparatus for controlling the size of the particle clumps which pass into the next particle separating zone. In the inventive apparatus, the fluid moving through the fluid connection may not have sufficient velocity to move all clumps and individual particles entering the fluid connection completely through the fluid connection. When the clumps and/or individual particles that enter the fluid connection do not move completely through the fluid connection, they are returned to the previous separation column. In an embodiment, the clumps and/or individual particles that do not move completely through the fluid connection, can be returned to the previous separation column with the aid of vibration of the walls of the fluid connection and/or gravity. The length of the fluid connection is determined by the average mass, average size and average shape of the particles and/or clumps of particles. FIG. 7 is a photograph showing different geometries of the fluid connection between the separation columns and points of possible accumulation of fibers.

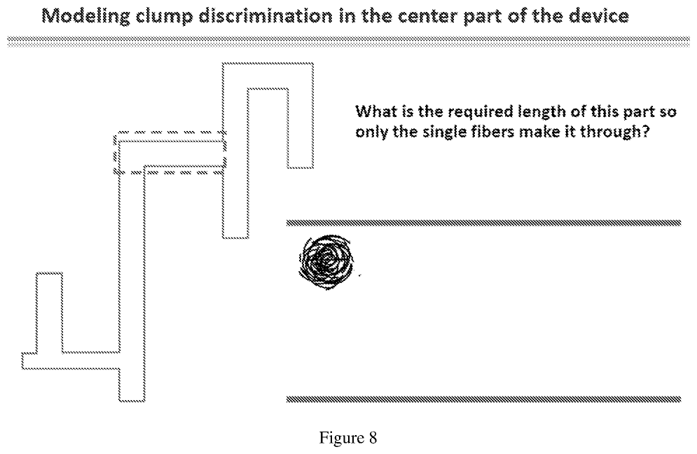

FIG. 8 is a representation of an embodiment of the inventive apparatus. The separation columns are shown in a vertical orientation. Therein, the drag on the particles is in the upward direction. The drag on the particles or clumps of particles depends on the area, shape, fluid velocity, fluid viscosity and density, and size of the particles or clumps of particles. If the drag is not high enough, the particle will drop. The fluid connection, circled with a dotted line, is a site where separation can occur. There is a competition between drag caused by the fluid horizontally and weight of the particles pulling down vertically as the particles cross the fluid connection. Whether the particles or clump of particles successfully cross the fluid connection depends on: a) the momentum of the particles entering the fluid connection; b) the diameter of the fluid connection; c) the length of the fluid connection; and d) the weight of the particles pulling the particles down.

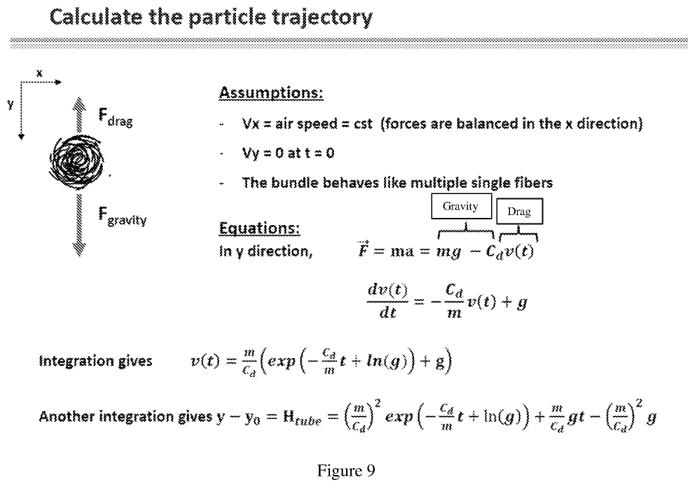

FIG. 9 is a mathematical expression of the particle dynamics. Y-y₀ is the vertical distance the particle will travel, which sets the vertical size, H_{tube} (i.e. diameter for a circular cross-section), and horizontal length of the fluid connection. The coefficient of drag C_{d} on the particles or clumps of particles depends on the Reynolds number with respect to the particle size and shape, inclination of the particle to the flow, flow conditions, and size of the particles or clumps of particles.

FIG. 10 describes factors in determining the drag coefficient C_{d} on the fiber or bundle. Specifically, drag coefficient C_{d} for a pitch fiber (from Mitsubishi Chemical Carbon Fiber and Composites, Inc.) having an aspect ratio of 500, a diameter of 12 microns and a length of 6 mm is shown. The drag coefficient C_{d} for this pitch fiber was calculated to be 1×10⁻⁴ Pa·s·m.

The fluid connection is an important part of the inventive apparatus for controlling the size of the particle clumps which pass into the next particle separating zone. FIG. 11 describes parameters for calculating the ideal dimensions of the fluid connection and/or particles to be separated. The density of the fiber clumps can be measured using Archimedes principle, i.e. the weight of the particles/clump in different liquids. The diameter can be measured with a microscopy image.

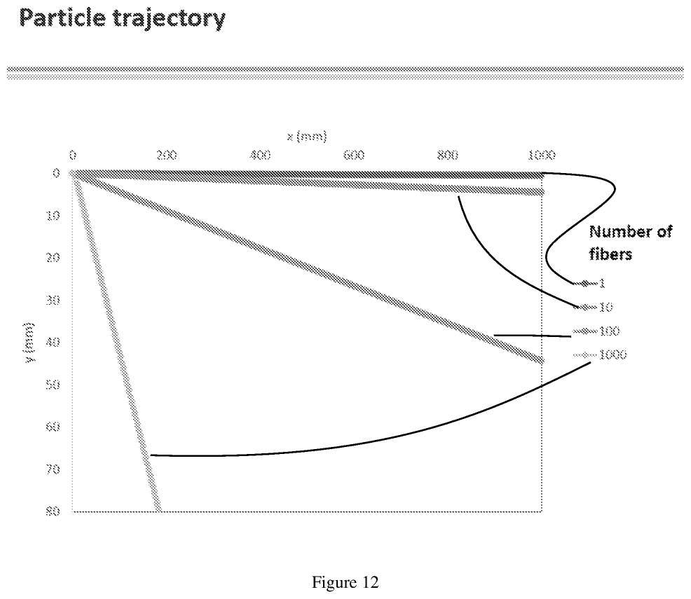

As noted above, the fluid connection is an important feature of the apparatus for controlling the size of the particles which move on to the next particle separating zone. Factors to consider when determining the diameter and length of a fluid connection are shown in FIG. 12. FIG. 12 is a graph of the particle trajectory and shows that as the number of fibers in the fiber bundle (or clump) increases, the particle will increase in rate travelled in the downward y direction per unit of distance in the x direction. Here, for simplicity, the coefficient of drag is kept constant. However, it is known that the coefficient of drag will depend in a nontrivial way on the number of particles in the bundle, the size and shape of the bundle, the kinematics of the flow field, the fluid properties, and the inclination of the particle/clump in the flow field. The graph shows that a clump of 100 fibers will fall about 40 mm as it travels 1000 mm along the length of the fluid connection. Also, the graph shows that a clump of 1000 fibers will fall about 80 mm as it travels about 200 mm along the length of the fluid connection. As such, the fluid connection could exclude all clumps having 1000 fibers while allowing clumps having 100 fibers to pass through if the fluid connection is 1000 mm in length and 60 mm in diameter, at the specified coefficient of drag.

The dimensions of the last fluid connection and the fluid flow rate therein can be controlled to allow essentially only single (non-clumped) fibers to pass through to the particle collector.

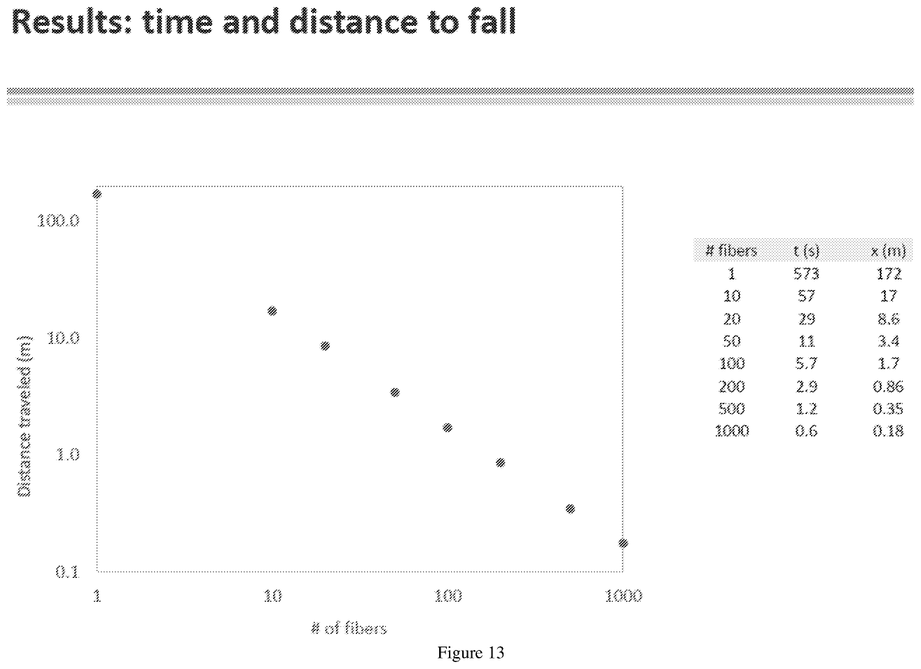

FIG. 13 is a graph of time and distance to fall with increased number of fibers in the bundle (or clump) at a fixed velocity. This information could also be used to choose the length of the chamber of the fluid connection for excluding particles greater than a certain weight. Based on this information, clumps of 10 fibers can be separated from clumps of 100 fibers by making the length of the horizontal section in the fluid connection to be between 1 to 10 meters.

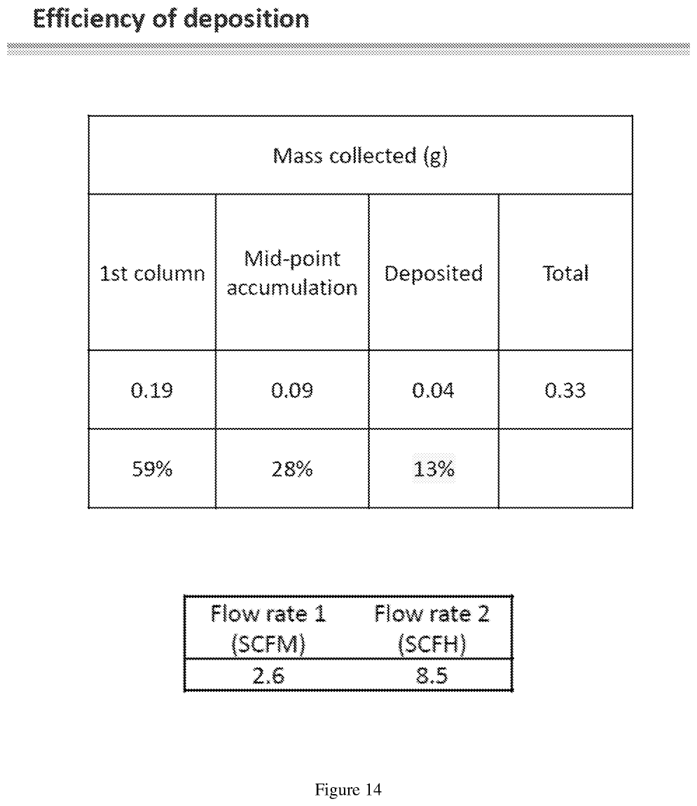

FIG. 14 is a table of data for an embodiment of the invention, wherein 0.33 g of fibers were fed into the apparatus of FIG. 1 and the apparatus was run for two minutes. At the bottom of the first column, 0.19 g (59 wt. %) of the mass of fibers were collected, 0.09 g (28 wt. %) of the mass of fibers were collected at a midpoint, and 0.04 g (13 wt. %) of single fibers were collected by the particle collector (last column). Flow rate 1 is the flow rate at Air inlet 1, and Flow rate 2 is the flow rate for Air inlet 2.

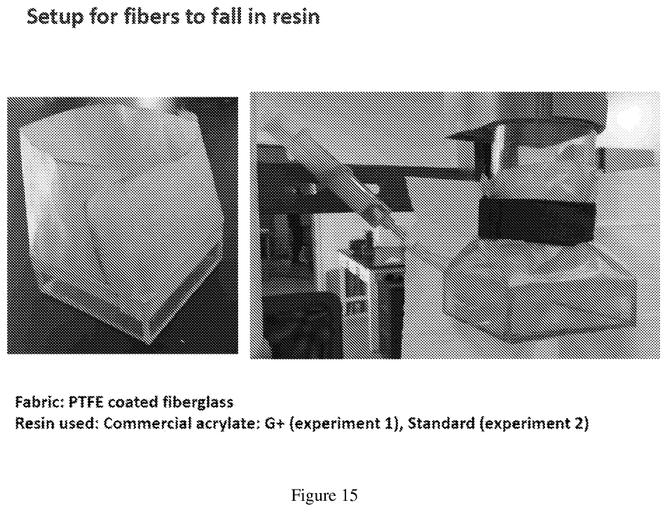

FIG. 15 is a photograph of a particle collector wherein the fibers fall into a resin bath. However, it is envisioned that the particles can pass through a spray or mist of a liquid coating material such as an anticorrosive material for metallic particles.

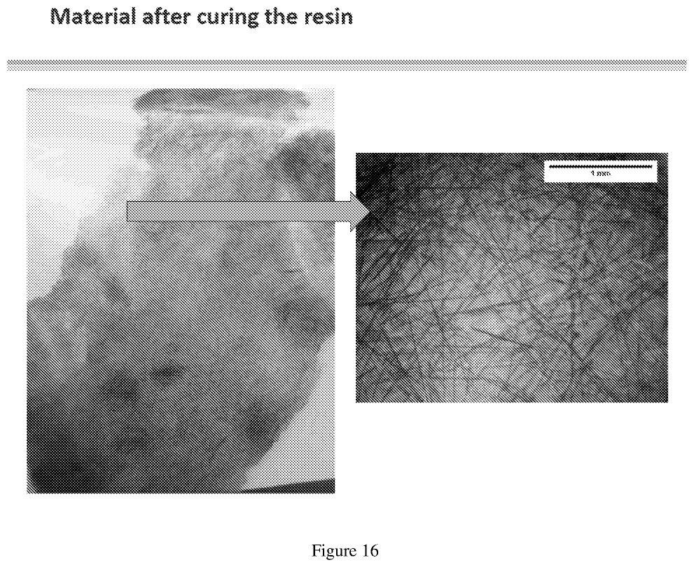

FIG. 16 are photographs of the collected fibers in a resin after curing the resin. The photographs show a lack of clumping.

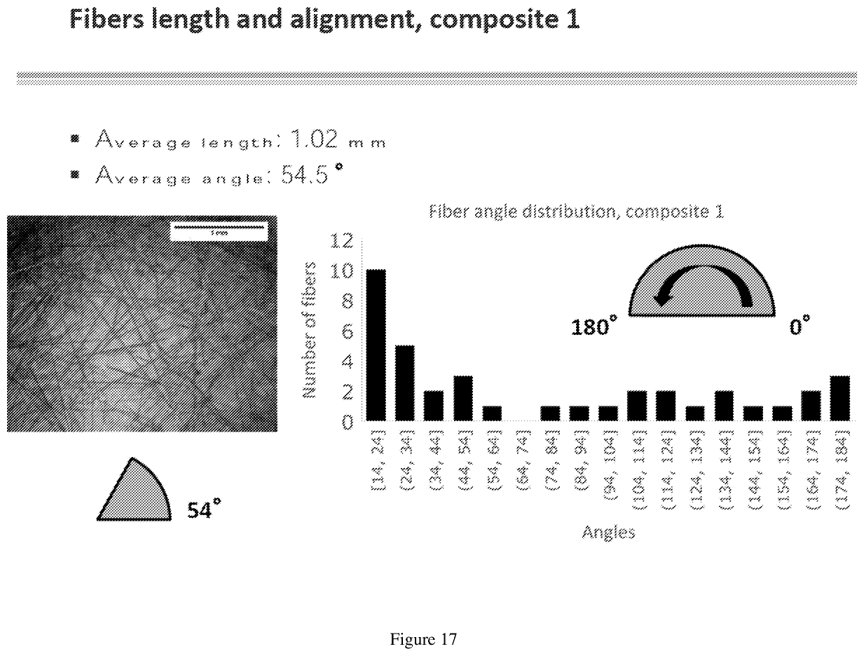

FIG. 17 shows a distribution of the number of fibers in each alignment within a composite. The average length of the fibers was 1.02 mm and the average angle was 54.5°. This shows that the deposition angle can be controlled in the inventive method.

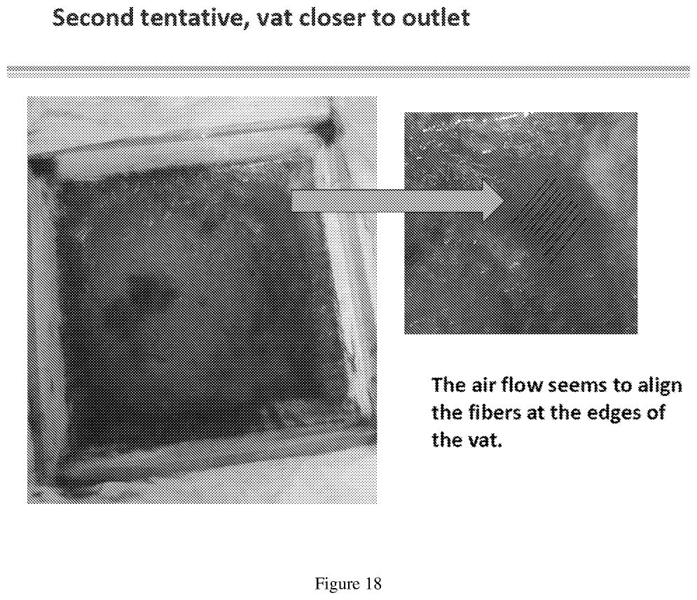

FIG. 18 are photographs of the vat wherein fibers are collected. The form of the deposition can be controlled by modifying the flow into the particle collector, and the length, diameter and porosity of the pipe of the particle collector. Here, there were more fibers collected on the perimeter of the particle collector. In the invention, the separated fibers can be added to a liquid directly or a liquid can be added to the collected fibers. The system can align the fibers as they are collected. Any method could be used to aid in the alignment including an electric field, velocity distribution (velocity field), confining the space (narrowing the walls) as fibers are collected, etc.

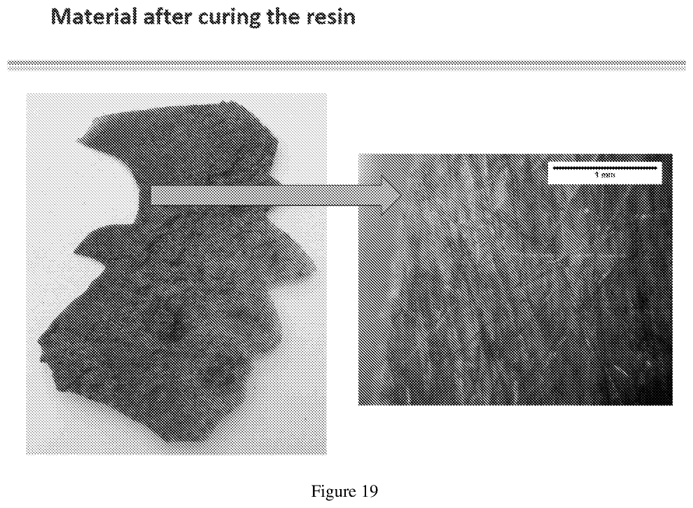

FIG. 19 are photographs of the material after curing of the resin.

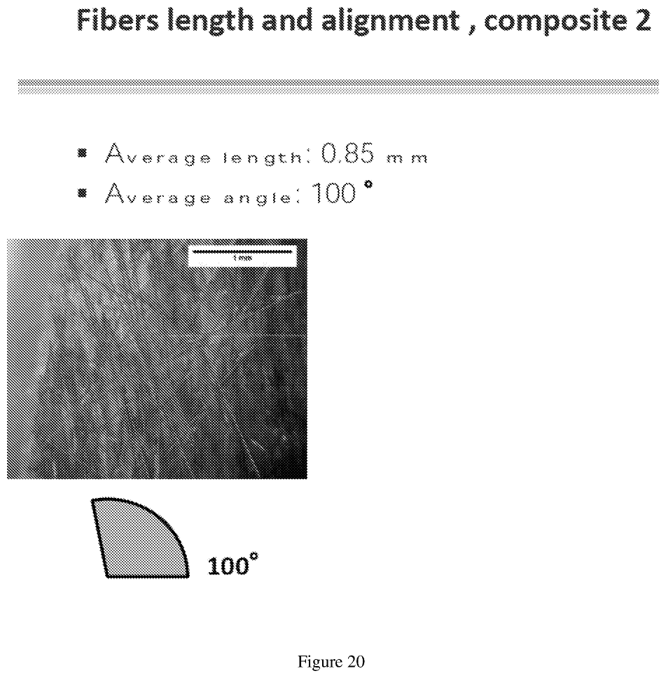

FIG. 20 is a microscopy image of a composite formed with fibers which exited the apparatus, and the average length of the fibers was 0.85 mm and the average angle was 100°.

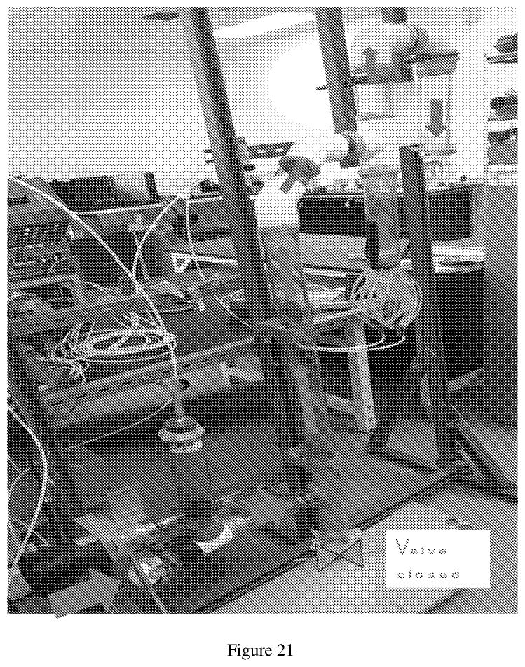

FIG. 21 is a photograph of an embodiment of the invention with arrows showing the direction of flow of the fluid and particles within the apparatus. In this embodiment, the bottom of the tube of the first separation column is closed off.

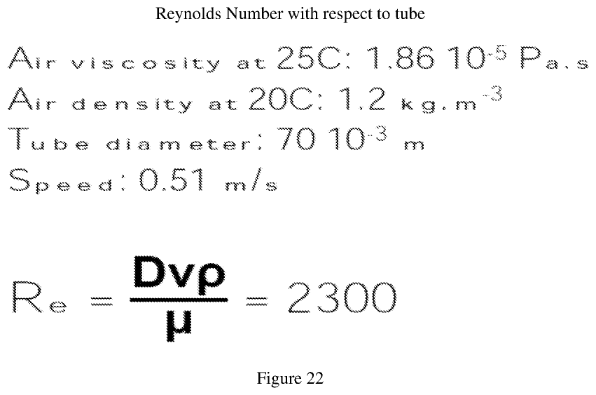

FIG. 22 shows the parameters of the Reynolds Number with respect to a tube.

The individual particles can have an aspect ratio of 1 to 30,000; or 50 to 30,000; or 1 to 1000; or 50 to 1000; or 100 to 1000; or greater than 300 to 1000. Preferably the fiber diameter of the individual particles is 10 nm to 100 microns, or 50 nm to 50 microns, and the length of the individual particles is 10 nm to 10 cm, or 1 micron to 1 cm or 10 microns to 50 microns. Timbrell (V. Timbrell, “The Inhalation of Fibrous Dusts”, Marrow Series of Annals of the New York Academy of Sciences, 1965, Vo. 132, Issue 1, Biological Effects of Asbestos: Section V. Human Exposure to Asbestos: Dust Controls and Standards, pages 255-273, https:doi.org/10.111/jr.1749-6632.1965.tb41007.x) outlines the relationship of equivalent diameter/fiber diameter for large aspect ratio objects, which explains how the separation is able to differentiate between particles based on mass. Timbrell is herein incorporated by reference in its entirety.

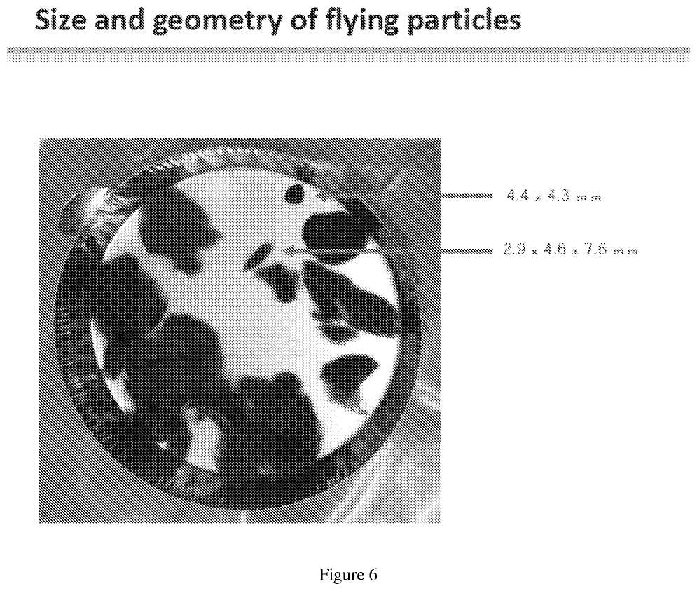

FIG. 6 is a photograph showing the size and geometry of particles that can be propelled in the inventive apparatus. The particles can be at least one selected from the group consisting of fiber particles, polymeric particles, protein particles, and cellulose particles; or wherein the particles are natural fiber particles or wherein the particles are carbon fiber particles, metal fiber particles, polyamide particles, or peptide particles. Preferably, the particles are carbon fiber particles. Preferably, the particles are not asbestos.

The inventive method can include a preprocessing step of breaking apart clumps of particles to reduce size of the clumps before being placed in the apparatus. Alternatively, there is no preprocessing step of breaking apart clumps of particles to reduce size of the clumps before being placed in the apparatus.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Other embodiments of the present disclosure will be apparent to those skilled in the art from consideration of the specification and practice of the embodiments disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims. The foregoing embodiments are susceptible to considerable variation in practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

It is to be understood that each component, compound, substituent or parameter disclosed herein is to be interpreted as being disclosed for use alone or in combination with one or more of each and every other component, compound, substituent or parameter disclosed herein.

It is also to be understood that each amount/value or range of amounts/values for each component, compound, substituent or parameter disclosed herein is to be interpreted as also being disclosed in combination with each amount/value or range of amounts/values disclosed for any other component(s), compounds(s), substituent(s) or parameter(s) disclosed herein and that any combination of amounts/values or ranges of amounts/values for two or more component(s), compounds(s), substituent(s) or parameters disclosed herein are thus also disclosed in combination with each other for the purposes of this description.

It is further understood that each range disclosed herein is to be interpreted as a disclosure of each specific value within the disclosed range that has the same number of significant digits. Thus, a range of from 1-4 is to be interpreted as an express disclosure of the values 1, 2, 3 and 4.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

1. An apparatus for separating individual particles from a collection of clumps (or bundles or aggregates) of particles, comprising
n number of separation columns, wherein each separation column is connected at an upper portion thereof to at least one fluid connection, wherein one of the separation columns connected to at least one fluid connection is defined as a particle separating zone thereby forming n particle separating zones,
each separation column includes a porous or nonporous structure located at a lower end of said separation column;
a particle collector;
a particle feeder fluidly connected to a first of said separation columns, said particle feeder being configured to feed both particles and clumps of particles to the first of said separation columns;
the nth fluid connection is connected at a downstream point to the particle collector;
one or more fluid sources which are fluidly connected with each of the separation columns for supplying pressurized fluid to the particle separating zone,
wherein each of the one or more fluid sources supplies pressurized fluid: i) through the porous or nonporous structure located at the lower end of the separating column; ii) through an opening in the separation column; iii) through an opening in the fluid connection; or iv) through an opening in the particle feeder,
wherein said fluid sources are configured such that said pressurized fluid:
a) suspends a portion of the clumps above the porous or nonporous structure and within the particle separating zone thereby separating at least some clumps into smaller clumps and/or individual particles; and
b) conveys a portion of the clumps and/or individual particles to the next separation column in the series of separation columns, or, in the case of the nth separation column conveys individual particles to the particle collector.

2. The apparatus according to claim 1, wherein there are 1 to 8 fluid connection(s) attached to a separation column.

3. The apparatus according to claim 1, wherein there is 1 fluid connection attached to each separation column in the apparatus.

4. The apparatus according to claim 1, wherein said fluid sources are configured such that said pressurized fluid b) conveys a portion of the clumps and/or individual particles below a predetermined size to the next separation column downstream.

5. The apparatus according to claim 1, wherein the apparatus is configured so that less than 10% of the individual particles collected in the particle collector are broken into significantly smaller particles during operation of the apparatus.

6. The apparatus according to claim 1, wherein the porous structure at the lower end of the separation column is configured to collect the clumps that are too heavy to be suspended by the pressurized fluid.

7. The apparatus according to claim 1, wherein said particle feeder includes:
a) a hopper configured to hold a collection of clumps of particles and individual particles to be separated,
b) a barrel,
c) a valve located between said hopper and said barrel, said valve being configured to regulate flow of the clumps of particles and individual particles from the hopper into the barrel, and
d) a source of pressurized fluid fluidly connected to said barrel and configured for conveying the clumps of particle and the individual particles from said hopper to the first of said particle separating zones.

8. The apparatus according to claim 1, wherein the value of n is 1 to 20.

9. The apparatus according to claim 1, wherein said particle collector further comprises a spraying unit for spraying polymer resin on the individual particles fed to the particle collector.

10. The apparatus according to claim 1, wherein openings in said porous structure in the bottom of the separation columns are sized to collect clumps and allow fluid to enter the particle separating zone.

11. The apparatus according to claim 1, wherein the pressurized fluid is supplied to the first particle separating zone such that the velocity is specified to drag all particles above a given length scale into the second separation column.

12. The apparatus according to claim 11, wherein the pressurized fluid is supplied to a second of the n particle separating zones such that the velocity is specified to drag a smaller subset of particles into the third separation column.

13. The apparatus according to claim 1, further comprising a porous structure located inside of and proximate a lower end of the particle collector to allow passage of fluid out of the particle collector while preventing passage of individual particles.

14. A method of separating individual particles from a collection of clumps of particles and individual particles with an apparatus comprising a series of n number of separation columns, wherein each separation column is connected at an upper portion thereof to at least one fluid connection, wherein one of the separation columns connected to at least one fluid connection is defined as a particle separating zone thereby forming n particle separating zones, and each separation column has a porous or nonporous structure at a lower end of the separation column, said method comprising steps of:
(A) providing the clumps of particles and individual particles to the first particle separating zones,
(B) providing pressurized fluid into each said particle separating zone with sufficient velocity so as to:
(i) suspend a portion of the clumps above the porous or nonporous structure and within the particle separating zone thereby separating at least some clumps into smaller clumps and/or individual particles; and
(ii) convey through a fluid connection having a predetermined length a portion of the clumps and/or individual particles to the next separation column in the series of separation columns, or, in the case of the nth separation column convey individual particles to a particle collector; and
(C) collecting individual particles in the particle collector,
wherein the pressurized fluid is supplied by one or more fluid sources: i) through the porous or nonporous structure located at the lower end of the separation column; ii) through an opening in the separation column; iii) through an opening in the fluid connection; or iv) through an opening in a particle feeder configured to provide the clumps of particles and individual particles to the first particle separating zone.

15. The method according to claim 14, wherein there are 1 to 8 fluid connections attached to a separation column.

16. The method of claim 14, wherein less than 10% of the individual particles collected in the particle collector are broken into significantly smaller particles.

17. The method of claim 14, wherein said method comprising supplying pressurized fluid vertically through the porous structure at the lower end of each said separation column, and wherein said pressurized fluid moves further within the fluid connection in a direction that is not vertical.

18. The method of claim 14, wherein said pressurized fluid moves within the fluid connection in a horizontal direction.

19. The method of claim 14, wherein the fluid moving through the fluid connection does not have sufficient velocity to move all clumps and individual particles entering the fluid connection completely through the fluid connection.

20. The method of claim 14, wherein the fluid flow is laminar and has a Reynolds Number of <3,000 with respect to the separation column and fluid connections.

21. The method of claim 19, wherein the clumps and/or individual particles that do not move completely through the fluid connection, are returned to the previous separation column with the aid of vibration of the walls of the fluid connection and/or gravity.

22. The method of claim 14, wherein cohesiveness of the clumps is overcome with fluid flow, collisions between individual clumps and collisions between clumps and inner walls of the apparatus in a flow path of the clumps and individual fibers.

23. The method of claim 14, wherein the individual particles have an aspect ratio of 1 to 30,000.

24. The method of claim 14, further comprising collecting particles that have passed through at least one particle separating zone in a resin bath to form a mixture of resin and particles, and curing the resin.

25. The method of claim 24, wherein the resin is a thermoset resin or a thermoplastic resin or an epoxy resin.
